(19) United States
(12) Patent Application Publication
(10) Pub. No.: US 2023/0156055 A1
(43) Pub. Date: May 18, 2023

(54) System for Transferring Data from a Moving Vehicle to a Remote Monitoring Node

(71) Applicant: The Boeing Company, Chicago, IL (US)

(72) Inventors: Jason Apanovitch, Marysville, WA (US); Christopher Michael Ellison, Lynnwood, WA (US); Shawn LaGrotta, Mukilteo, WA (US)

(21) Appl. No.: 17/528,814

(22) Filed: Nov. 17, 2021

(51) Int. Cl. H04L 29/06; G07C 5/00; B64D 47/08; H04L 29/08; H04N 7/18

(52) U.S. Cl. CPC H04L 65/4069; B64D 47/08; G07C 5/008; H04L 67/26; H04L 67/141; H04N 7/181; H04N 5/913

(57) ABSTRACT

A computing device positioned in a vehicle for streaming data from the vehicle to a monitoring node. The computing device includes communications circuitry and processing circuitry operatively connected to the communications circuitry. The processing circuitry is configured to: establish a secure communication tunnel with the monitoring node while the vehicle is moving; obtain data to be streamed to the monitoring node; translate the data into a message using a publish-and-subscribe protocol; initiate a communication session with the monitoring node; and transmit the message from the vehicle to the monitoring node via the secure communication tunnel.

### TECHNOLOGICAL FIELD

The present disclosure relates generally to systems for transferring data and, more specifically, systems that transfer data from a vehicle to a remote node in a secure and real-time manner.

### BACKGROUND

Various types of vehicles include video surveillance systems that provide for monitoring activities that occur on or with the vehicle. The video is saved in local storage and archived. The relevant video can be accessed and retrieved if there is an event that requires a review of the activities of the vehicle.

An issue with these systems is the amount of video data collected is too large to simply be uploaded continuously to the cloud. The process of uploading, storing, and subsequently accessing the video data is inefficient and untimely. This type of system can also be expensive to implement and maintain. In one application for aircraft used for long-haul flights, operators rely on SATCOM for uploading the video during flight. While this system does work, there is significant cost associated with moving data to and from the vehicle.

Another issue is the delay in recording and accessing the video data. There are events in which it is necessary to access the data in a real-time period. For example, video may be needed in near real-time to address events involving terrorism, human trafficking and many other international crimes. Current systems introduce a lag in accessing the information which may require the event to conclude before the data is available to be retrieved. Further, some events may prevent the video data from being uploaded and thus the data may not be recoverable.

In addition to video data, there is also other types of data that are recorded at a vehicle and stored. Examples include but are not limited to phase-of-flight transitions for an aircraft, security event markers, audio markers, and various sensor data. This data should also be managed in a manner that can provide for real-time review.

### SUMMARY

One aspect is directed to a computing device positioned in a vehicle to stream data from the vehicle to a monitoring node. The computing device comprises communications circuitry and processing circuitry operatively connected to the communications circuitry. The processing circuitry is configured to: establish a secure communication tunnel with the monitoring node while the vehicle is moving; obtain data to be streamed to the monitoring node; translate the data into a message using a publish-and-subscribe protocol; initiate a communication session with the monitoring node; and transmit the message from the vehicle to the monitoring node via the secure communication tunnel.

In another aspect, the processing circuitry is configured to obtain the data from storage on the vehicle.

In another aspect, the processing circuitry is configured to obtain the data from one or more cameras in the vehicle.

In another aspect, the processing circuitry is configured to obtain the data in response to receiving a request from the monitoring node.

In another aspect, the processing circuitry is further configured to: encrypt the data; save the encrypted data at the vehicle; initiate the communication session with the monitoring node; after initiating the communication session, receive a request for the data; and in response to receiving the request, decrypt the data prior to translating the data into the message.

In another aspect, the publish-and-subscribe protocol is an MQTT protocol.

In another aspect, the secure communication tunnel is a TLS tunnel with a first endpoint at the vehicle and a second endpoint at the monitoring node.

In another aspect, the processing circuitry initiates the communication session based on an event that occurs with the vehicle.

One aspect is directed to a computing device to transfer data from a moving vehicle to a monitoring node located remotely from the vehicle. The computing device comprises a memory circuitry configured to store computer-readable program code, and processing circuitry configured to execute the computer-readable program code to cause the computing device to: establish a communication tunnel with the monitoring node; initiate a communication session with the monitoring node; after initiating the communication session, receive a request for the data from the monitoring node with the request being received through the communication tunnel; obtain the data from one or more cameras positioned in the vehicle; in response to the request, translating the data into a message using MQTT protocol; and transmit the data through the communication tunnel from the vehicle to the monitoring node.

In another aspect, the processing circuitry is further configured to obtain the data from a specific one of the cameras that is indicated in the request.

In another aspect, the image processing circuitry is configured to: obtain the data prior to receiving the request; encrypt the data; store the encrypted data; in response to the request, decrypt the encrypted data; and transmit the data through the communication tunnel from the vehicle to the monitoring node.

In another aspect, the processing circuitry is configured to transmit the data to the monitoring node prior to saving the data at the vehicle.

In another aspect, the vehicle is an aircraft and the processing circuitry is configured to transmit the data during flight.

One aspect is directed to a method of transmitting data from a moving vehicle to a remote monitoring node located away from the vehicle. The method comprises: capturing the data through one or more cameras located in the vehicle; after initiating communication, receiving a request to transfer the data to the monitoring node; establishing a secure communication tunnel between the vehicle and the monitoring node; and transferring the data from the vehicle to the monitoring node through the secure communication tunnel.

In another aspect, the method further comprises transferring the data from the vehicle through one or more satellites and then to the monitoring node.

In another aspect, the method further comprises storing the data at the vehicle prior to transferring the data to the monitoring node.

In another aspect, the method further comprises translating the data using MQTT protocol and subsequently transferring the data to the monitoring node.

In another aspect, the method further comprises receiving a request from the monitoring node to access the data and in response transferring the data from the vehicle to the monitoring node.

In another aspect, the method further comprises transferring the data through the secure communication tunnel separately as video packets and audio packets.

In another aspect, the method further comprises live streaming the data captured by the one or more cameras through the secure communication tunnel.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a perspective view of a vehicle equipped with a computing device.

FIG. 2 is a schematic diagram of a communication network.

FIG. 3 is a schematic diagram of a section of the communication network that includes a secure tunnel that extends between a vehicle and a monitoring node.

FIG. 4 schematic diagram of a computing device transmitting image data in separate data packets.

FIG. 5 is a flowchart diagram of a method of a processing one or more messages that are transmitted to the vehicle.

FIG. 6 is a flowchart diagram of a method of processing image data that is transmitted to a monitoring node.

FIG. 7 is a flowchart diagram of a method of receiving image data and transmitting the image data to a monitoring node.

FIG. 8 is a flowchart diagram of a method of requesting and receiving image data from a vehicle.

FIG. 9 is a schematic diagram of a computing device and monitoring node that form endpoints on a secure communication tunnel.

FIG. 10 is a block diagram of functional units of a processing circuitry of the computing device.

### DETAILED DESCRIPTION

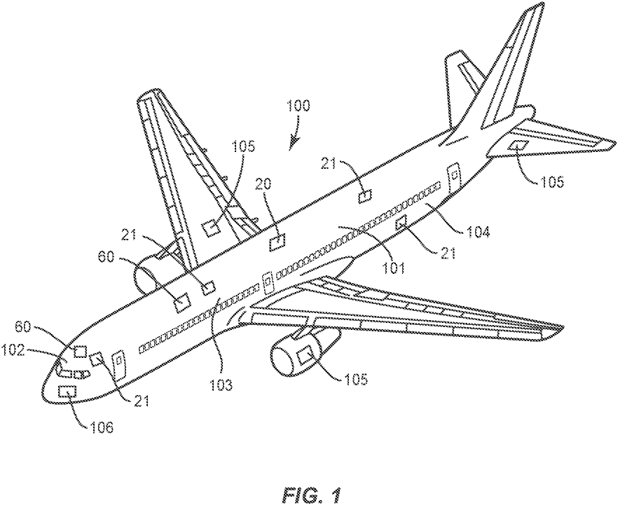

FIG. 1 illustrates a vehicle 100 equipped with a computing device 20 configured to collect and transmit data. In one example, the vehicle 100 is an aircraft 100, although the computing device 20 can be used within a variety of different vehicles 100. In this example, the vehicle 100 includes one or more cameras 21 configured to capture images from within the vehicle 100. The cameras 21 can be positioned at various locations. FIG. 1 includes an example with cameras 21 positioned in the flight deck 102, cabin area 103, and cargo hold 104. The cameras 21 are configured to record video and/or individual images of the areas in the vehicle 100. The cameras 21 may include microphones to capture audio associated with the images. In another example, separate microphones are positioned in proximity to the cameras 21 to capture the audio. Various types of cameras 21 can be used to capture the video. In one example, the cameras 21 include power over ethernet (PoE) cameras 21. The computing device 20 is operatively connected to the cameras 21. Image data captured by the cameras 21 is sent to the computing device 20.

One or more control panels 60 are positioned on the vehicle 100 to allow persons onboard the vehicle 100 to view the image data. The control panels 60 can be positioned at one or more locations within the vehicle 100, including but not limited to the flight deck 102 for viewing by the flight deck personnel (e.g., pilot, co-pilot) and the cabin area 103 for viewing by other flight crew members. In one example, the control panels 60 are wireless tablets that can be carried by flight personnel throughout the vehicle 100.

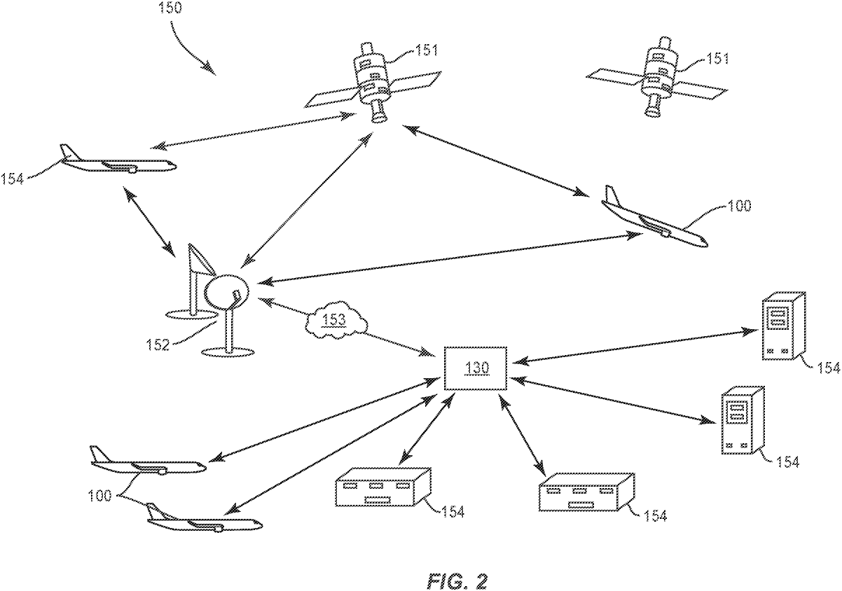

The computing device 20 is configured to transmit the image data through a communication network 150 to a remote monitoring node 130. FIG. 2 includes an example with the vehicle 100 being an aircraft that is in flight with the monitoring node 130 positioned on the ground and being remote from the aircraft 100. The communication system 150 includes satellites 151 that receive the image data from the aircraft 100 during flight. The satellite 151 transmits the image data to a ground station 152 which transmits the image data through a network 153 (e.g., Internet) to the remote monitoring node 130. The monitoring node 130 in turn communicates with one or more nodes 154, such as but not limited to ground airline operations center, devices associated with security personnel, other vehicles 100, and devices associated with emergency response service providers including various local, state, and federal agencies.

The communication system 150 is configured to support offboard connectivity to transmit the image data while the vehicle 100 is moving. In one example with an aircraft 100, this occurs during flight. In one example, the image data is streamed in real time from the vehicle 100. Thus, personnel on the ground are able to receive images and/or video of events that are occurring on the vehicle 100 in real time. In another example, the image data is stored at the vehicle 100 and subsequently transmitted to the monitoring node 130 for access by the one or more nodes 154.

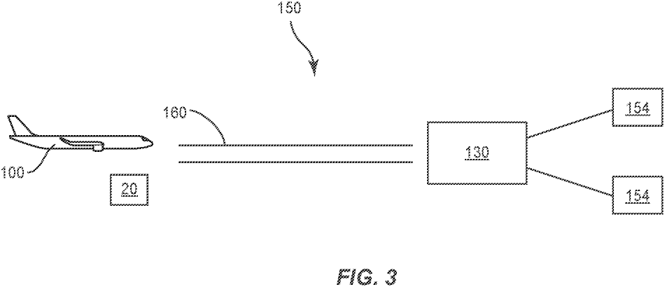

FIG. 3 illustrates a section of the communication system 150 that provides the connectivity between the vehicle 100 and the monitoring node 130. This section of the communication system 150 includes a cryptographically secure point-to-point tunnel 160 that is established between the vehicle 100 and the monitoring node 130. In one example, a certificate-based system is employed to provide mutual authentication to establish a TLS tunnel 160 and to authorize access to trusted services. The amount and speed of the image data available through the tunnel 160 can vary.

The computing device 20 establishes the tunnel 160 that includes certificate-based functionality that provides mutual authentication (e.g. according to 802.1x) of the end-points of the tunnel 160, establish the TLS tunnel 160, and authorize access to trusted services. The computing device 20 includes a Public Key Infrastructure (PKI) that manages and maintains the certificates, as well as installs, revokes, and securely stores the certificates.

The monitoring node 130 provides an opposing endpoint for the tunnel 160. The monitoring node 130 authenticates inbound connection requests from the vehicle 100. Once authenticated, the image data is received at the monitoring node 130 and transmitted or otherwise made accessible to the one or more nodes 154. The image data can also be stored by the monitoring node 130 for later access. The monitoring node 130 can encrypt the image data prior to providing access to the nodes 154 and/or transmitting the image data to the nodes 154. In one example, the image data is encrypted utilizing a single-use AES 256 key and encrypting that AES 256 key with a public key.

In one example, the monitoring node 130 includes image player circuitry for viewing the image data. The monitoring node 130 receives the real-time image data pushed by the vehicle 100 and the image player circuitry provides for viewing the image data. In one example, the image player circuitry provides for web-based access for viewing of the image data by the one or more nodes 154. The image player circuitry provides for various viewing functionality, including but not limited to pausing, rewinding and fast forwarding up to the point of receipt of the image data.

The monitoring node 130 provides for remote control of the computing device 20 and/or cameras 21 onboard the vehicle 100. This control provides for remote personnel to select the applicable image data for remote viewing. The control can also provide for the remote user to adjust one or more of the cameras 21 to obtain the desired image data. The control of the computing device 20 and cameras 21 can be performed by personnel stationed at the monitoring node 130 and/or at one of the nodes 154.

In one example, the monitoring node 130 is configured to provide a web interface for access by the nodes 154. The monitoring node 130 is configured for accessing image data using a browser-based interface or an applications program interface (API). The browser-based interface can include a website through which the image data can be accessed. The website can be hosted by the monitoring node 130 or at another location accessible through the network 153.

The cryptographically secure point-to-point tunnel 160 is established when connectivity is available and the computing device 20 makes a request to connect to the monitoring node 130 and the identities of both endpoints is mutually authenticated. The computing device 20 and the monitoring node 130 participate in a certificate-based mutual authentication process to validate the identities of the endpoints. Once authenticated, the cryptographically secure TLS-based tunnel 160 is established and maintained via heartbeat signals or messages.

In one example, security restrictions require that the vehicle 100 initiate connections with the monitoring node 130. These restrictions prevent the use of conventional bidirectional connection negotiations that provide for the monitoring node 130 to initiate a connection. To satisfy these security restrictions, a publish-and-subscribe architecture is used for exchanging the image data between the vehicle 100, monitoring node 130, and nodes 154. The monitoring node 130 acts as a broker that relays image data downloaded from the vehicle 100 to the nodes 154. Further, the monitoring node 130 collects and stages messages from the nodes 154 intended for uploading to the vehicle 100. For example, in one example monitoring node 130 receives and stages the messages intended to be sent to vehicle 100. In one example, the messages may be staged in a local memory, or in memory accessible to the monitoring node 130. As stated above, monitoring node 130 does not initiate a connection with vehicle 100 and therefore does not send the messages to vehicle 100 until it receives a connection initiation request from the computing device 20 on the vehicle 100. Once the monitoring node 130 receives the connection initiation request from the vehicle 100 and the connection is established, the monitoring node 130 transmits the staged messages to the vehicle 100.

The publish-and-subscribe architecture further provides for each of the messages to be categorized by one or more topics. The image data messages are transmitted to the one or more nodes 154 that subscribe to the topic. For example, image data may be categorized by a topic of “cargo hold”. A node 154 for shipping analysis may be subscribed to this topic, and therefore would receive the image data for this topic through the monitoring node 130. A second node associated with safety functions on the vehicle 100 may not subscribe to this topic and therefore would not receive the “cargo hold” image data. The number of topics can vary.

In one example, messages received at the monitoring node 130 during times when the computing device 20 has not initiated a connection are timestamped and staged by the monitoring node 130. The messages are held by the monitoring node 130 until the vehicle 100 initiates a connection with the monitoring node 130 and requests the messages.

In one example, the publish-and-subscribe architecture uses Message Queuing Telemetry Transport (MQTT) protocol. The MQTT protocol is built on the TCP/IP protocol and provides real-time reliable messaging services to the nodes 154 with minimal code and limited bandwidth. The MQTT protocol runs on TCP and is an application layer protocol. Therefore, the MQTT protocol can be used in application scenarios that support the TCP/IP protocol stack. MQTT includes a publish-subscribe messaging pattern that uses the monitoring node 130 as a message broker to distribute messages to the applicable nodes 154 based on the topic of a message. Typically, there are multiple MQTT topics available, which are associated with different nodes 154.

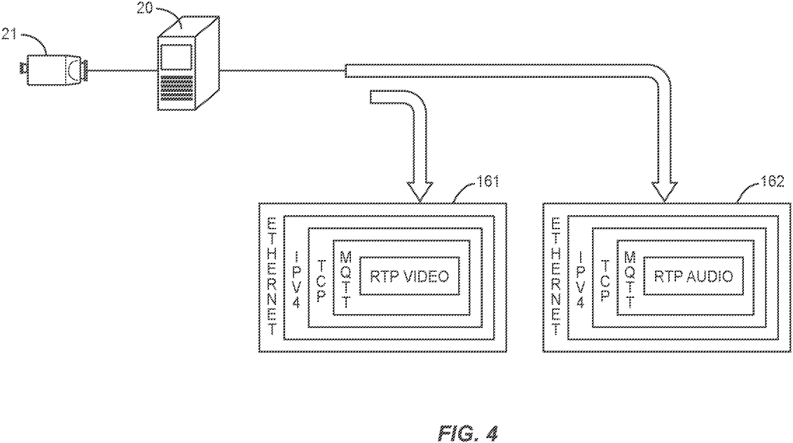

FIG. 4 illustrates the broad level functionality of the transmission of the image data from the vehicle 100 to the monitoring node 130. Image and corresponding audio data is captured by a camera 21 and associated microphone that is onboard the vehicle 100. The image and audio data is transferred from the camera 21 and microphone via an onboard communications network to the computing device 20. In one example, the camera 21 and computing device 20 are connected by ethernet connections that are part of a local area network within the vehicle 100. In one example, the image and audio data is communicated to the computing device 20 using a Real-Time Transport Protocol (RTP). The computing device 20 then generates separate packets 161, 162 for the image data and the audio data, respectively, and transmits the packets 161, 162 to the monitoring node 130 using the MQTT protocol. In one example, the computing device 20 and the monitoring node 130 communicate using an Internet Protocol version 4 (IPv4).

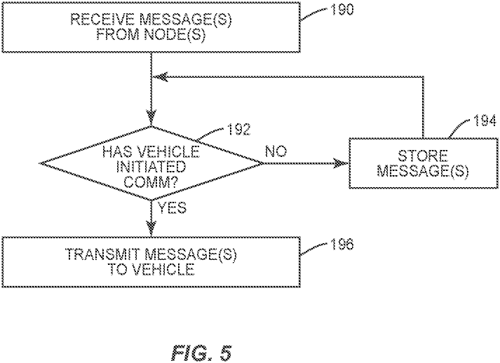

FIG. 5 illustrates a method of transmitting one or more messages from the monitoring node 130 to the vehicle 100. The monitoring node 130 receives one or more messages from one or more of the nodes 154 (block 190). The monitoring node 130 determines whether the vehicle 100 is in vehicle-initiated communication (block192). If the vehicle 100 has not initiated communication, the monitoring node 130 stores the one or more messages (block 194). In one example, the monitoring node 130 timestamps the messages when received. If the vehicle 100 has initiated communication, the monitoring node 130 transmits the one or more messages to the vehicle 100 (block 196).

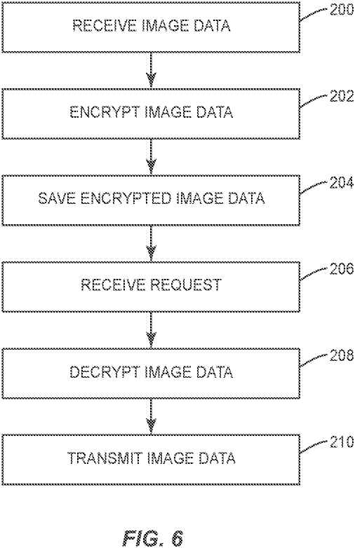

The messages received at the vehicle 100 can includes requests for previously recorded data and/or real-time data. FIG. 6 illustrates a method of the vehicle 100 handling image data and responding to a request for the image data. Initially, the image data is received by the computing device 20 from one or more of the cameras 21 (block 200).

After receipt, the image data is encrypted (block 202) and saved (block 204) by the computing device 20. At some point thereafter, a request is received from one or more of the nodes 154 for the image data (block 206). The request can be for the entirety of the image data or for one or more discrete portions. After receiving the request, the image data is decrypted (block 208) and transmitted to the monitoring node 130 (block 210). In one example, the image data is transmitted using the MQTT protocol.

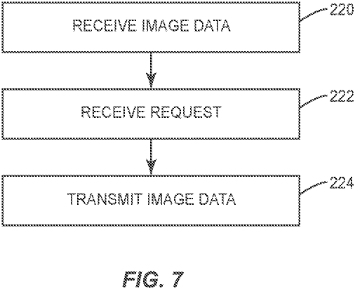

The processing circuitry 23 can also receive requests for real-time image data. For these situations, the image data is not initially encrypted and/or stored at the vehicle 100. FIG. 7 illustrates a method of handling real-time image data. The image data is received by the computing device 20 from the one or more cameras 21 (block 220). A request for the image data is also received (block 222). After receiving the request, the image data is transmitted to the monitoring node 130 (block 224). In one example, the image data is transferred using the MQTT protocol.

In one example, the request is received prior to the image data being captured. In response to the request, the computing device 20 causes the one or more cameras 21 to capture the scene. In another example, the computing device 20 receives image data continuously and/or on periodic intervals. Prior to receiving the request, the receive image data is encrypted and stored and transmitted as disclosed in FIG. 6. Image data that is obtained after receiving the request is not encrypted and/or stored, but rather transmitted directly to the monitoring node 130.

The real-time image data includes one or more images, video, and/or audio of events that are currently occurring on the vehicle 100. The events are captured in real-time, although there may be delays (latency) caused by the process of capturing and transmitting/accessing the image data. The latency can be caused by one or more of the time for the cameras 21 to capture the images, the transmission of the image data to the computing device 20, the transmission to the monitoring node 130 due to the speed of data transfer (bps), and displaying the image data on a display screen (either at the monitoring node 130 or other node 154). In one example, what the viewer views on their display will have a delay from when the event actually occurred.

Nodes 154 can access the image data at the monitoring node 130 through a variety of devices, including but not limited to laptop computers, personal computers, personal digital assistants, mobile computing/communication, tablet devices, and various other-like computing devices. Each of the nodes 154 accesses the monitoring node 130 either directly through a dedicated network or through the network 153 (e.g., Internet). In one example, one or more of the nodes 154 accesses the monitoring node 130 through a separate portal. Each node’s portal can include a secure interface through which the node 154 can access the image data and have access to one or more of the vehicles 100. In one example, nodes 154 are assigned one or more vehicles 100 from which they can receive the image data.

In one example, the monitoring node 130 is configured for browser-based accessibility. The browser-based interface can support well-known browsers. Alternatively, or in conjunction the nodes 154 can obtain the image data using one or more APIs.

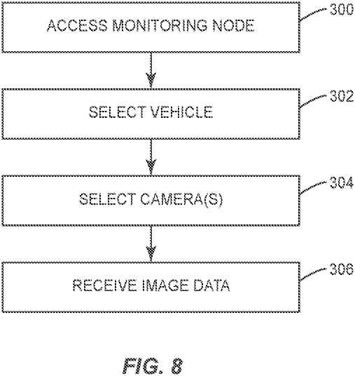

FIG. 8 illustrates a method of a node 154 obtaining image data from the vehicle 100. The node 154 accesses the monitoring node (block 300). In one example, identifying information and passwords are used to authenticate the node 154 and, provided authentication is successful, allow the access. Once connected with the monitoring node 130, the node 154 selects the applicable vehicle 100 (block 302). The monitoring node 130 can provide access to one or more vehicles 100 that are located at various locations. In one example, a vehicle identification ID is input, such as a registration number. Once the vehicle 100 has been selected, the node 154 selects the one or more cameras that are to provide the image data (block 304). Once the one or more cameras 21 are selected, the request is made to the vehicle 100. In addition to selecting the one or more cameras 21, the request can also include the type of media which can include one or more still images (e.g., single pictures), previously recorded video, or a live video stream. Once the vehicle 100 initiates communication, the request is transmitted to the vehicle 100 which processes the request and transmits the image data (block 306). The image data is then either accessed by the node 154 at the monitoring node 130 or transmitted by the monitoring node 130 to the node 154.

The aspects disclosed above include the transmission of image data that is captured by one or more cameras 21. The structures and processes are also applicable for gathering and transmitting other types of data. On example includes one or more sensors 105 (see FIG. 1) are positioned on the vehicle 100. The sensors 105 detect one or more physical properties (e.g., temperature, speed, elevation, flight detect door position, motion detection). Another example includes various event markers that are detected onboard the vehicle, such as but not limited to phase-of-flight transitions, security event markers (e.g., abnormal onboard traffic events), and audio-only transfers such as VOIP. In one example, these different aspects are detecting by control circuitry 106 that oversees the travel of the vehicle 100. In one specific example with an aircraft, the control circuitry 106 is a flight controller that monitors the multiple systems operating on the aircraft during flight. In another example, the aspect can be input from a control panel 60 such as by a person onboard the vehicle 100. As with the image date, this other information can be saved by the computing device 20 and transmitted to the monitoring node 130 at a later time and/or transmitted in real-time.

In one example, the computing device 20 assigns different topics to the data based on the data type. For example, a first topic includes image data which is assigned a topic for publication to a first set of nodes 154, and a second topic includes flight control data which is assigned a different topic for publication to a second set of nodes.

In one example, the vehicle 100 initiates the communication with the monitoring node 130. This can include the vehicle 100 periodically initiating communication at predetermined time periods. Additionally or alternatively, a specific predetermined event that occurs on the vehicle 100 can trigger or cause computing device 20 into initiating the establishment of a secure communications tunnel 160 with the monitoring node 130. In one example, an unplanned or sudden change in vehicle movement (e.g., change in flight path, change in elevation, change in course, change in speed) may trigger or cause the computing device 20 to initiate the establishment of a secure communications tunnel 160 with the monitoring node 130. In another example, detected motion in an area of the vehicle 100 not typically known for movement during flight operations (e.g., the cargo hold) can trigger the computing device 20 to initiate the establishment of a secure communications tunnel 160. Initiating the establishment of the secure communications tunnel 160 may be performed automatically, such as in response to a signal output by one or more sensors, or be performed manually, such as responsive to input by onboard personnel. For example, a flight crew member may input a command or provide a signal to the computing device 20 through a control panel 60. In response to receiving the input, computing device 20 would initiate the establishment of the secure communications tunnel with the monitoring node 130.

In one example, the computing device 20 is configured to automatically trigger data transfers to the monitoring node 130 at predetermined times and/or predetermined events. Specific examples include but are not limited to automatically pushing one or more images or video during takeoff and landing of the aircraft 100.

The computing device 20 is configured to communicate with the monitoring node 130 through the communication network 150 by available connections. These connections are requested by the vehicle 100 when available. Once proper credentials are established, the connection is established enabling bi-directional secure transmission of data using the MQTT protocol.

In one example, the hierarchy is established by a customer using the system (e.g., airline, airport). For example, a customer defines the hierarchy that includes satellite communications for airports A, B, and C. Communications at airports A and B occur through the available satellite communications. However, airport C has spotty coverage through satellites and a connection may not be available. When not available, the vehicle 100 determines that a cellular connection is available and communication occurs through the cellular system. In this instance, the computing device 20 changes from the default satellite communications to cellular communications upon detection of the cellular signal.

The communication network 150 and architecture provide for a single monitoring node 130 to monitor multiple different vehicles 100. Further, the communications network 150 can include additional vehicles 100. A vehicle 100 can transmit and receive data from other vehicles 100 to each other while moving. In the specific application of aircraft, this includes the aircraft transmitting and receiving data during flight from other aircraft.

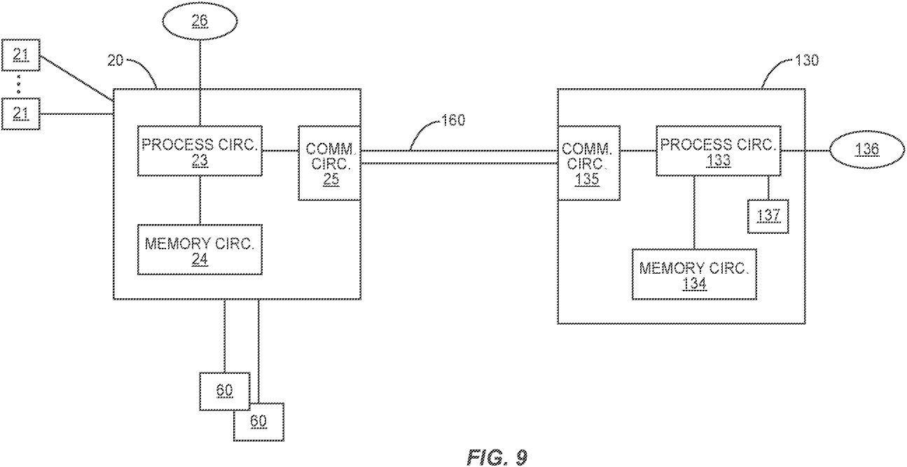

FIG. 9 illustrates a schematic diagram of the computing device 20 that forms a first endpoint for the tunnel 160 and the monitoring node 130 that forms a second endpoint. The computing device 20 is positioned on the vehicle 100 and the monitoring node 130 is positioned remote from the vehicle 100. Each of the computing device 20 and monitoring node 130 includes processing circuitry 23, 133. The processing circuitry 23, 133 can include one or more microprocessors, microcontrollers, Application Specific Integrated Circuits (ASICs), or the like, configured with appropriate software and/or firmware. Computer readable storage medium (shown respectively as memory circuitry 24, 134) stores data and computer readable program code that configures the processing circuitry 23, 133 to implement the various communication techniques. Memory circuitry 24, 135 is a non-transitory computer readable medium and may include various memory devices such as random access memory, read-only memory, and flash memory. The memory circuitry 24 is configured to store computer-readable program code with the processing circuitry 23 configured to execute the computer-readable program code to cause the computing device 20 to perform the various functions. Likewise, the memory circuitry 134 is configured to store computer-readable program code with the processing circuitry 133 configured to execute the computer-readable program code to cause the monitoring node 130 to perform the various functions.

Communications circuitry 25, 135 provides for communication through the tunnel 160. Communications circuitry 135 of the monitoring node 130 also provides for communication with the nodes 154. Databases 26, 136 store information relevant and include a non-transitory computer readable storage medium (e.g., an electronic, magnetic, optical, electromagnetic, or semiconductor system-based storage device). The databases 26, 136 can be local or remote relative to the respective image processing circuitry 23, 133.

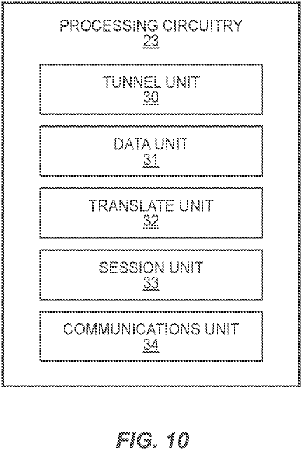

FIG. 10 illustrates a computer program product in accordance with one or more examples of the present disclosure. As seen in FIG. 10, computer program product includes one or more functional units or modules that, when executed by the processing circuitry 23, configure the computing device 20 to implement the functions of the present disclosure, as previously described. In this example, the units and/or modules comprising the computer program product may include, but are not limited to, a secure tunnel establishing unit/module 30, a data obtaining unit/module 31, a data translation unit/module 32, a session establishment unit/module 33, and a communications unit/module 34.

The secure tunnel establishing unit/module 30 comprises instructions that, when executed by the processing circuitry 23, causes the computing device 20 to initiate the establishment of a secure communications tunnel 160 with the monitoring node 130, as previously described. The data obtaining unit/module 31 comprises instructions that, when executed by the processing circuitry 23, causes the computing device 20 to obtain the data to be streamed from the computing device 20 to the monitoring node 130, as previously described. The data translation unit/module 32 comprises instructions that, when executed by the processing circuitry 23, causes the computing device 20 to translate the data obtained by data obtaining unit/module 31 into a message using a publish-and-subscribe protocol, as previously described. The session establishment unit/module 33 comprises instructions that, when executed by the processing circuitry 23, causes the computing device 20 to establish a communication session with the monitoring node 130 over the secure communications tunnel 160, as previously described. The communications unit/module 34 comprises instructions that, when executed by the processing circuitry 23, causes the computing device 20 to transmit the translated message to the monitoring node 130, and to receive data messages from the monitoring node 130, as previously described.

One or more control panels 60 are positioned on the vehicle 100 and provide for onboard monitoring of the captured data. The control panel 60 include a display for displaying the image data for viewing by onboard personnel. One or more input devices such as but not limited to a keyboard and mouse provide for a user to control the control panel. The control panel 60 can also include a browser for accessing the image data and/or controlling the transmission. The control panel 60 can also include a port to input data that is to be transmitted to the computing device 20. In one example, the port provides for input of image data stored on memory cards.

In one example as disclosed above, the vehicle 100 initiates the communications sessions that includes the transfer of data with the monitoring node 130. In another example, the communications provide for the monitoring node 130 to initiate communication and data transfer with the vehicle 100. This communication can be initiated in various manner, including but not limited to at predetermined timed intervals and upon receiving a request from a node 154.

The systems and methods described can be used on a variety of vehicles 100. Vehicles 100 include but are not limited to manned aircraft, unmanned aircraft, manned spacecraft, unmanned spacecraft, manned rotorcraft, unmanned rotorcraft, satellites, rockets, missiles, manned terrestrial vehicles, unmanned terrestrial vehicles, manned surface water borne vehicles, unmanned surface water borne vehicles, manned sub-surface water borne vehicles, unmanned sub-surface water borne vehicles, and combinations thereof.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A computing device positioned in a vehicle to stream data from the vehicle to a monitoring node, the computing device comprising:
communications circuitry; and
processing circuitry operatively connected to the communications circuitry and configured to:
establish a secure communication tunnel with the monitoring node while the vehicle is moving;
receive a request from the monitoring node for data comprising images from a camera that is mounted in the vehicle;
adjusting the camera to obtain the images that were requested from the monitoring node;
translate the data into a message using a publish-and-subscribe protocol;
initiate a communication session with the monitoring node; and
transmit the data from the vehicle to the monitoring node via the secure communication tunnel.

2. The computing device of claim 1, wherein the processing circuitry is configured to_{:}
record additional images from the camera during a time period before the request;
encrypt and store the additional images as additional data on the vehicle;
after receiving the request, obtain the additional data from storage on the vehicle, decrypt the additional data and transmit the additional data via the secure communication tunnel.

3-4. (canceled)

5. The computing device of claim 1, wherein the processing circuitry is further configured to:
encrypt the data;
save the encrypted data at the vehicle;
initiate the communication session with the monitoring node;
after initiating the communication session, receive the request for the data;
in response to receiving the request, decrypt the data prior to translating the data into the message.

6. The computing device of claim 1, wherein the publish-and-subscribe protocol is an MQTT protocol.

7. The computing device of claim 1, wherein the secure communication tunnel is a TLS tunnel with a first endpoint at the vehicle and a second endpoint at the monitoring node.

8. The computing device of claim 1, wherein the processing circuitry initiates the communication session based on an event that occurs with the vehicle.

9. A computing device to transfer data from a moving vehicle to a monitoring node located remotely from the vehicle, the computing device comprising:
memory circuitry configured to store computer-readable program code;
processing circuitry configured to execute the computer-readable program code to cause the computing device to:
obtain real-time data from one or more cameras that are positioned within the vehicle, the data comprising images captured from within the vehicle;
encrypt and store the data;
establish a communication tunnel with the monitoring node;
initiate a communication session with the monitoring node;
after initiating the communication session, receive a request for the data from the monitoring node with the request being received through the communication tunnel;
decrypt the requested data and transmit the data through the communication tunnel from the vehicle to the monitoring node_{:} and
transmit real-time images of the interior of the vehicle that were captured after receiving the request, the real-time images being transmitted through the communication tunnel without encrypting and storing the images.

10. The computing device of claim 9, wherein the processing circuitry is further configured to obtain the data from a specific one of the cameras that is indicated in the request.

11. (canceled)

12. The computing device of claim 9, wherein the processing circuitry is configured to transmit the data to the monitoring node prior to saving the data at the vehicle.

13. The computing device of claim 9, wherein the vehicle is an aircraft and the processing circuitry is configured to transmit the data during flight.

14. A method of transmitting data from a moving vehicle to a remote monitoring node located away from the vehicle, the method comprising:
capturing the data through one or more cameras located in the vehicle;
encrypting and storing the data at the vehicle;
after initiating communication, receiving a request to transfer the data to the monitoring node;
establishing a secure communication tunnel between the vehicle and the monitoring node;
decrypting the data and transferring the data from the vehicle to the monitoring node through the secure communication tunnel; and
directly transmitting data captured after receiving the request without encrypting or storing the data at the vehicle.

15. The method of claim 14, further comprising transferring the data from the vehicle through one or more satellites and then to the monitoring node.

16. (canceled)

17. The method of claim 14, further comprising translating the data using MQTT protocol and subsequently transferring the data to the monitoring node.

18. The method of claim 14, further comprising receiving a request from the monitoring node to access the data and in response transferring the data from the vehicle to the monitoring node.

19. The method of claim 14, further comprising transferring the data through the secure communication tunnel separately as video packets and audio packets.

20. The method of claim 14, further comprising live streaming the data captured by the one or more cameras through the secure communication tunnel.

21. The computing device of claim 1, further comprising the processing circuitry configured to receive recorded audio from within the vehicle and transmit the audio from the vehicle to the monitoring node via the secure communication tunnel.

22. The computing device of claim 1, further comprising the processing circuitry configured to transmit the data in real time from the vehicle to the monitoring node.

23. The computing device of claim 1, further comprising the processing circuitry configured to display the data on a display within the vehicle for viewing by onboard personnel.

24. The computing device of claim 1, further comprising the processing circuitry configured to initiate the communications with the monitoring node through the communication tunnel.
